(19) United States
(12) Patent Application Publication
(10) Pub. No.: US 2018/0376085 A1
(43) Pub. Date: Dec. 27, 2018

(54) Method and apparatus for correcting smear artifacts

(71) Applicant: MAX-PLANCK-GESELLSCHAFT ZUR FÖRDERUNG D. WISSENSCHAFTEN E.V., München (DE)

(72) Inventors: Stefan TABEL, Feldafing (DE); Korbinian WEIKL, München (DE)

(21) Appl. No.: 15/940,524

(22) Filed: Mar. 29, 2018

(30) Foreign Application Priority Data
Mar. 31, 2017 (DE) 10 2017 003 170.3

(51) Int. Cl. H04N 5/359; H04N 5/3725

(52) U.S. Cl. CPC H04N 5/3595; H04N 5/3725

(57) ABSTRACT

1. Method and device for correcting readout smear artifacts.

2.1. Known methods for correcting smear artifacts that occur when reading out CCD sensors require considerable computing time; their implementation is cumbersome. The new method should enable more simple and efficient implementations.

2.2 In order to enable an efficient calculation of a corrected image, the readout image values and the correction values to be used are first transformed with a suitable transformation into a frequency range in which the transformed image values are then corrected by means of the transformed correction values through use of a folding operation. The folding can then be calculated in parallel. Furthermore, a method for approximately calculating corrections for an aperiodic readout smear is provided. Different efficient implementations in hardware are introduced.

2.3 Based on their efficiency, the method and the device are suitable in particular for scientific sensors that require high fill factors of the pixels but also for image sensors that are used in smartphones.

The invention relates to a method and device, which correct images from framestore or full-frame Charge-Coupled Devices (CCDs) of readout smear and thereby calculate the corrections in the frequency range.

CCDs are image sensors that create charges from incident photons and shift the created charge to evacuate the sensor. Framestore CCDs shift the charge generated in a pixel through neighboring pixels into a shielded framestore area so that the analog-to-digital conversion of a photo can be parallelized with the exposure of the following photo. Full-frame CCDs shift the charges directly into an amplifier instead of into a framestore area so that no parallelization takes place.

In full-frame and framestore CCDs, the charges are shifted through neighboring pixels. If the camera does not have a shutter, then the shifted charges continue to be illuminated during the displacement through neighboring pixels, whereby the image error of readout smear occurs.

Current cameras with framestore CCDs allow a high cadence, little noise, large pixels and few additional structures on a sensor. However, framestore CCDs cannot be electronically shuttered. Many framestore CCDs are too fast for mechanical shutters, which can then necessitate an algorithmic correction of the resulting readout smear.

In scientific cameras, a correction of several hundred images per second may be needed. In the case of consumer cameras, it is also desirable that a photo be displayed corrected with the least possible latency. There is thus interest in methods that determine the readout smear correction with less complexity and thus in a shorter period of time. Moreover, a correction with low complexity results in less energy consumption of the correction.

U.S. Pat. No. 8,169,515 B2 shows a method, which corrects the readout smear error with matrix-vector multiplications. Powell et al. (K. Powell, D. Chana, D. Fish, and C. Thompson, “Restoration and frequency analysis of smeared CCD images,” Applied Optics, vol. 38, no. 8, pp. 1343-1347, 1999) considers the standard scenario of the readout smear. A framestore CCD is run through by an image in 4 cycles. The image with zero values is shifted into the photosensitive area in the shifting-in cycle. This leads to an error through exposure during the shifting in so that a charge is created in each transfer cycle, the charge depending on the ratio of the delta of the transfer time and the exposure time. During the exposure, the image is located entirely in the photosensitive area and is illuminated with the actual scene. In the shifting-out cycle, the image is shifted into the framestore area, wherein an incorrect exposure in turn occurs. In the readout cycle, the image is located in the framestore area and is digitized.

Powell described the image error as smear S, which always occurs in a column along the shifting direction of this column. The column S contains the image information and the degradation through smear. Y is the column with image information and without smear. Powell established a connection via the circulant matrix M:

$$S = MY : ( \begin{matrix}{S}_{0} \\ {S}_{1} \\ {S}_{2} \\ ⋮ \\ {S}_{N - 1}\end{matrix} ) = [ \begin{matrix}1 & δ & δ & … & δ \\ δ & 1 & δ & … & δ \\ δ & δ & 1 & … & δ \\ ⋮ & ⋮ & ⋮ & ⋱ & ⋮ \\ δ & δ & δ & … & 1\end{matrix} ] ( \begin{matrix}{Y}_{0} \\ {Y}_{1} \\ {Y}_{2} \\ ⋮ \\ {Y}_{N - 1}\end{matrix} )$$

Powell corrected the column S to Y by means of:

Y=M⁻¹S

Powell (aaO) and Ruyten [W. Ruyten, “Smear correction for frame transfer charge-coupled-device cameras,” Optics Letters, vol. 24, pp. 878-880, July 1, 1999] introduced independently of each other the scenario for charge flush and reverse clocking. A charge-flush operation grounds all pixels of the image before the exposure or respectively sets all image values to zero. Reverse clocking shifts the image opposite the shifting direction during the shifting in. In both cases, the image degradation is again described with a matrix vector multiplication:

$$( \begin{matrix}{S}_{0} \\ {S}_{1} \\ {S}_{2} \\ ⋮ \\ {S}_{N - 1}\end{matrix} ) = [ \begin{matrix}1 & 0 & 0 & … & 0 \\ t * δ & 1 & 0 & … & 0 \\ t * δ & t * δ & 1 & … & 0 \\ ⋮ & ⋮ & ⋮ & ⋱ & ⋮ \\ t * δ & t * δ & t * δ & … & 1\end{matrix} ] ( \begin{matrix}{Y}_{0} \\ {Y}_{1} \\ {Y}_{2} \\ ⋮ \\ {Y}_{N - 1}\end{matrix} ) , t ∈ [ 1 , 2 ] ;$$

The value t is equal to 1 for charge flush and equal to 2 for reverse clocking.

Iglesias et al. (F. A. Iglesias, A. Feller, and K. Nagaraju, “Smear correction of highly variable, frame-transfer CCD images with application to polarimetry,” Applied Optics, vol. 54. no. 19, Jun 2015) consider the periodic scenario of readout smear. There, it is assumed that the scene between exposure and shifting out changes, with which Iglesias described a polarimetric modulation. This leads to a mathematical description of the smear using two matrices:

$${S}^{k} = {AY}^{k} + {BY}^{k + 1} , \\ ( \begin{matrix}{S}_{0}^{k} \\ {S}_{1}^{k} \\ {S}_{2}^{k} \\ ⋮ \\ {S}_{N - 1}^{k}\end{matrix} ) = [ \begin{matrix}1 + α & {δ}_{1} & {δ}_{1} & … & {δ}_{1} \\ 0 & 1 + α & {δ}_{1} & … & {δ}_{1} \\ 0 & 0 & 1 + α & … & {δ}_{1} \\ ⋮ & ⋮ & ⋮ & ⋱ & ⋮ \\ 0 & 0 & 0 & … & 1 + α\end{matrix} ] ( \begin{matrix}{Y}_{0}^{k} \\ {Y}_{1}^{k} \\ {Y}_{2}^{k} \\ ⋮ \\ {Y}_{N - 1}^{k}\end{matrix} ) + [ \begin{matrix}α & 0 & 0 & … & 0 \\ {δ}_{2} & α & 0 & … & 0 \\ {δ}_{2} & {δ}_{2} & α & … & 0 \\ ⋮ & ⋮ & ⋮ & ⋱ & ⋮ \\ {δ}_{2} & {δ}_{2} & {δ}_{2} & … & α\end{matrix} ] ( \begin{matrix}{Y}_{0}^{k + 1} \\ {Y}_{1}^{k + 1} \\ {Y}_{2}^{k + 1} \\ ⋮ \\ {Y}_{N - 1}^{k + 1}\end{matrix} )$$

A column S with smear now depends on the current column with the same time index k as well as on the following column with successor index k+1. Iglesias assumed for the periodic scenario that an image occurred periodically with a periodicity K so that the correlation applies:

$$S = MY : ( \begin{matrix}{S}_{0} \\ {S}_{1} \\ {S}_{2} \\ ⋮ \\ {S}^{K - 1}\end{matrix} ) = [ \begin{matrix}A & B & 0 & … & 0 \\ 0 & A & B & … & 0 \\ 0 & 0 & A & … & 0 \\ ⋮ & ⋮ & ⋮ & ⋱ & ⋮ \\ B & 0 & 0 & … & A\end{matrix} ] ( \begin{matrix}{Y}_{0} \\ {Y}_{1} \\ {Y}_{2} \\ ⋮ \\ {Y}^{K - 1}\end{matrix} )$$

The matrix M can be inverted again in order to solve for Y. M and its inverse are in this case block-circulant and invertible.

Moreover, Iglesias calculated the column Y with time index k under the condition that the images do not repeat themselves periodically:

$${Y}^{k} = {\sum }_{j = 1}^{K - k - j} {H}^{K - k - j} {A}^{- 1} {S}^{K - j} + {H}^{K} {Y}^{K} ; {H}^{K} = {( - {A}^{- 1} B )}^{K}$$

Iglesias showed that the last term of the equation can be disregarded since the system is dampened.

However, the known methods include high computing effort and lead to more complex implementations.

The object of the invention is thus the provision of a method and a device, which enables a faster and simpler correction of the readout smear.

This object is solved by a method and a device according to the independent patent claims. Advantageous embodiments are specified in the dependent claims.

Further aspects and advantages of the invention will become evident in the following description of exemplary embodiments with reference to the individual figures of the included drawing.

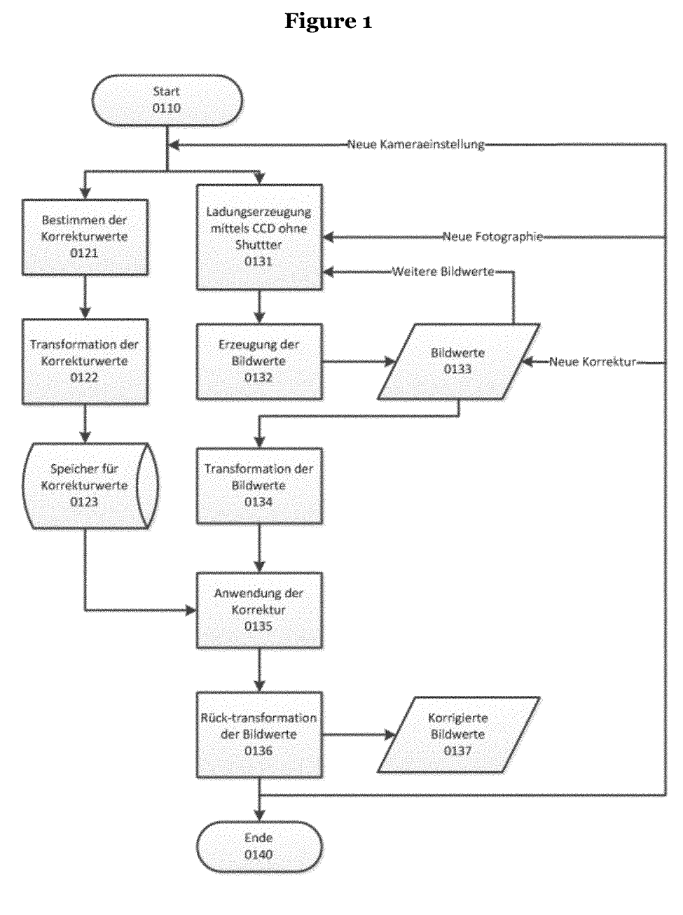

FIG. 1 thereby shows a method for correcting readout smear according to a first embodiment of the invention.

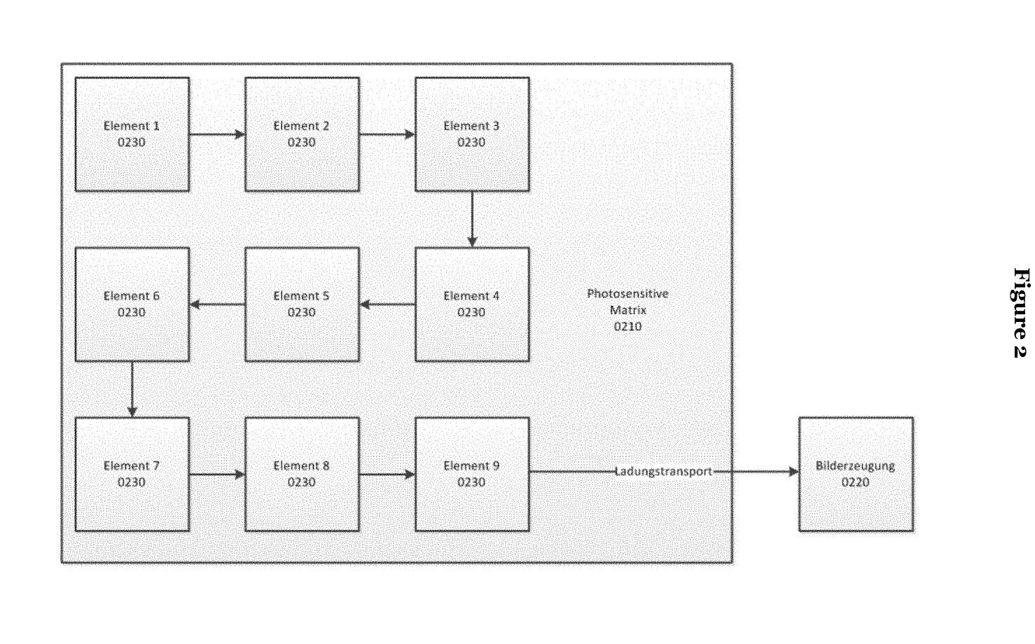

FIG. 2 shows the schematic structure of a full-frame CCD.

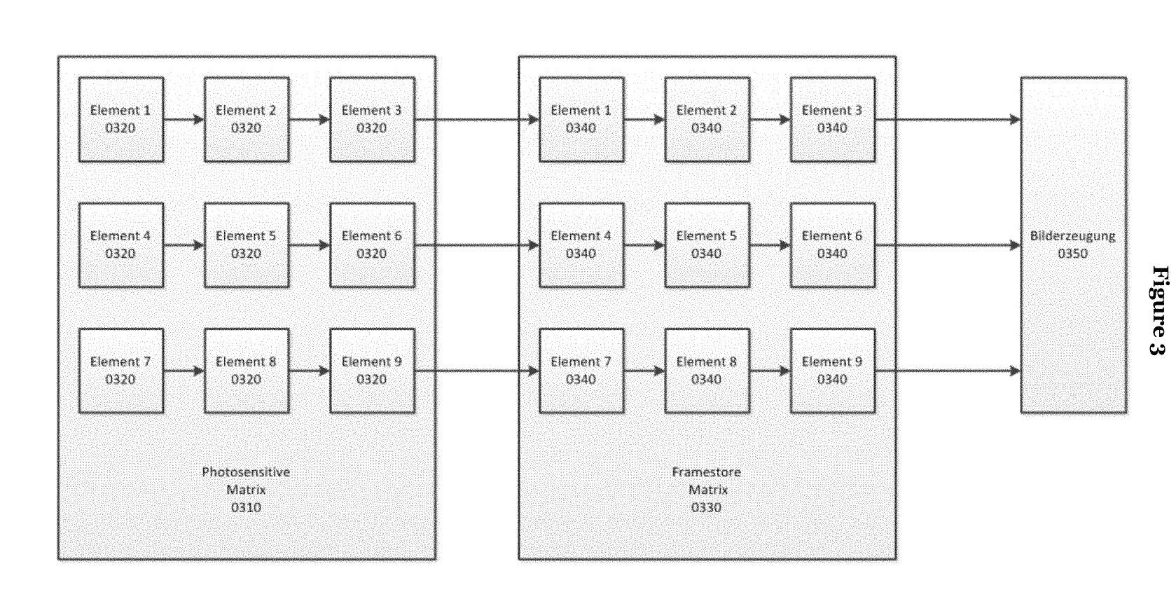

FIG. 3 shows the schematic structure of a frame-transfer CCD.

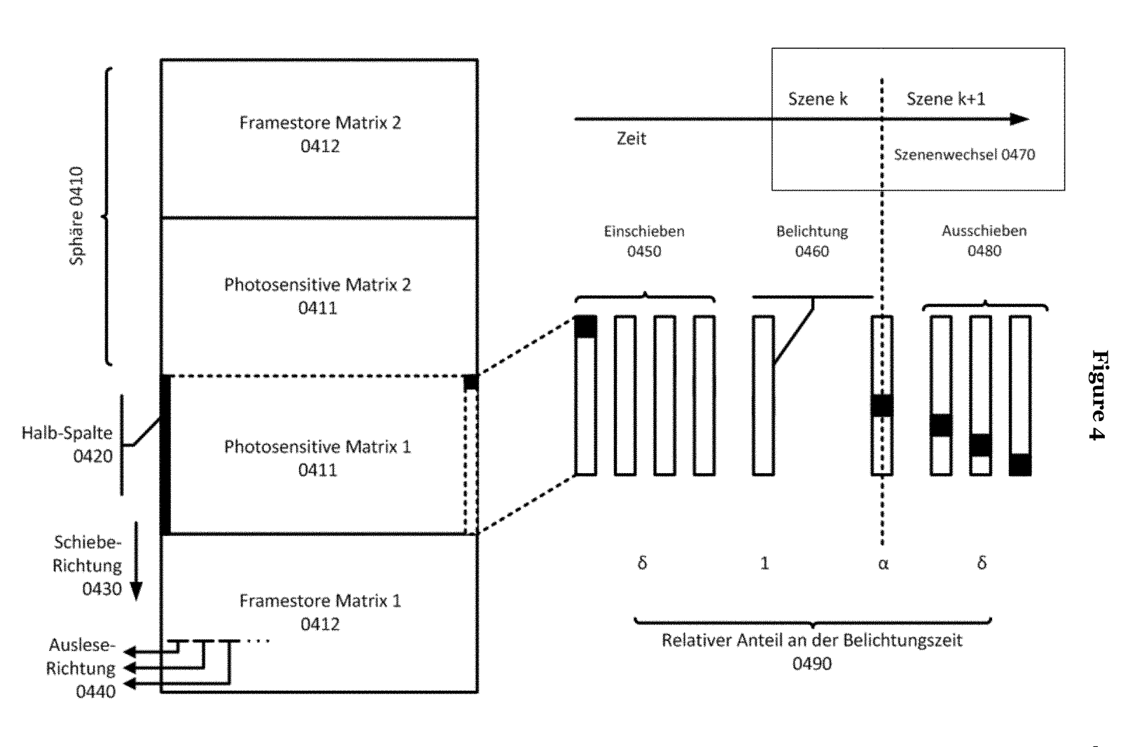

FIG. 4 shows a structure of the sensor and its process of image generation in the Fast Solar Polarimeter camera according to one embodiment of the invention.

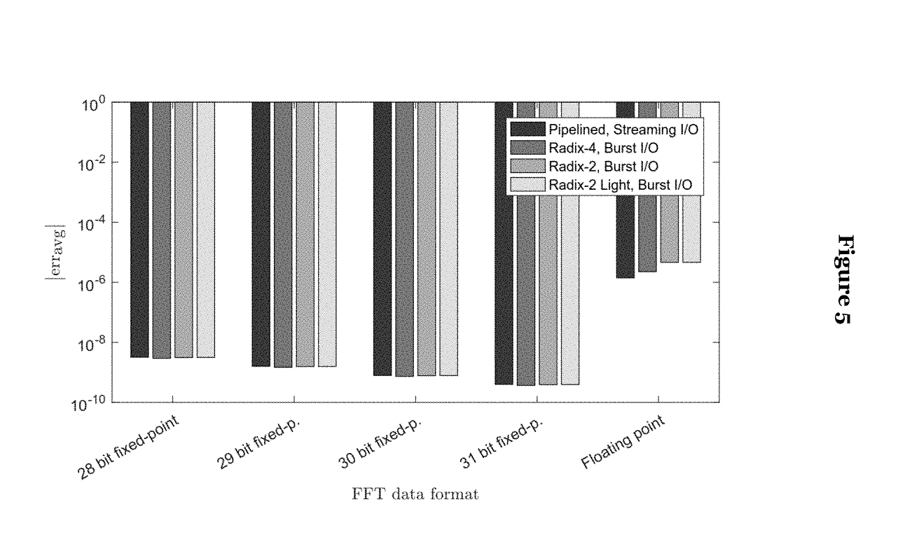

FIG. 5 shows measurement results for comparing a floating-point data format with several fixed-point data formats with different bit widths.

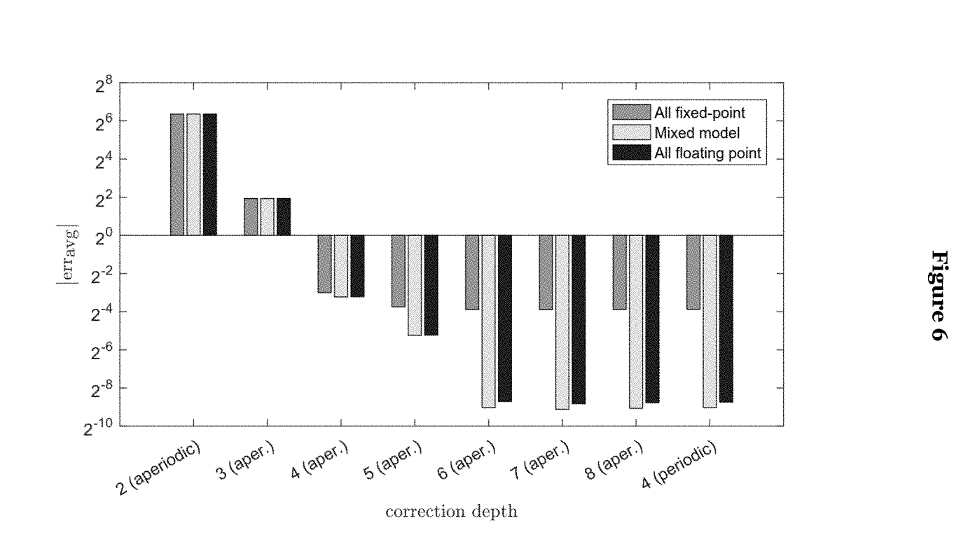

FIG. 6 shows measurement results for the aperiodic correction of images which were smeared periodically with a periodicity of four.

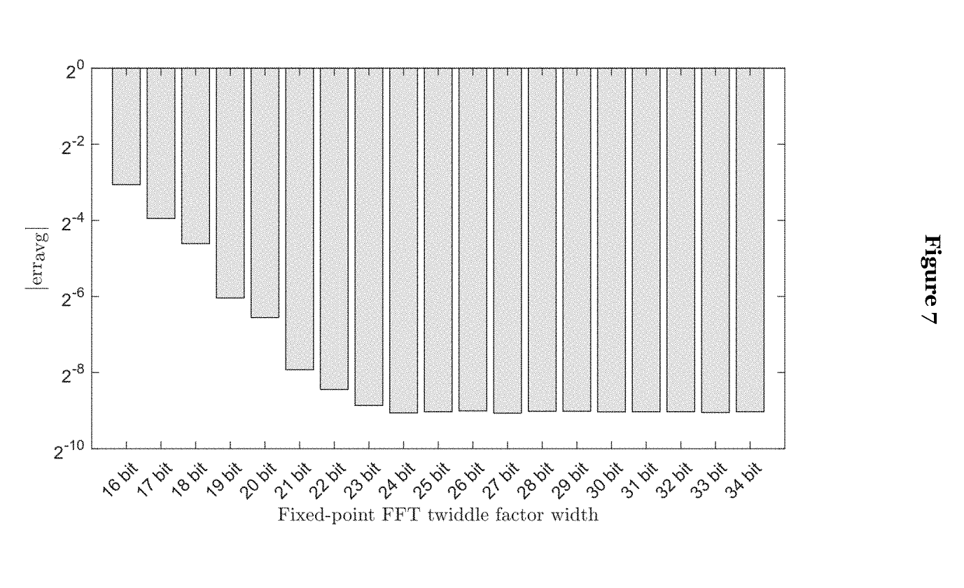

FIG. 7 shows the average signal value of difference images between aperiodically corrected and original, non-degraded images.

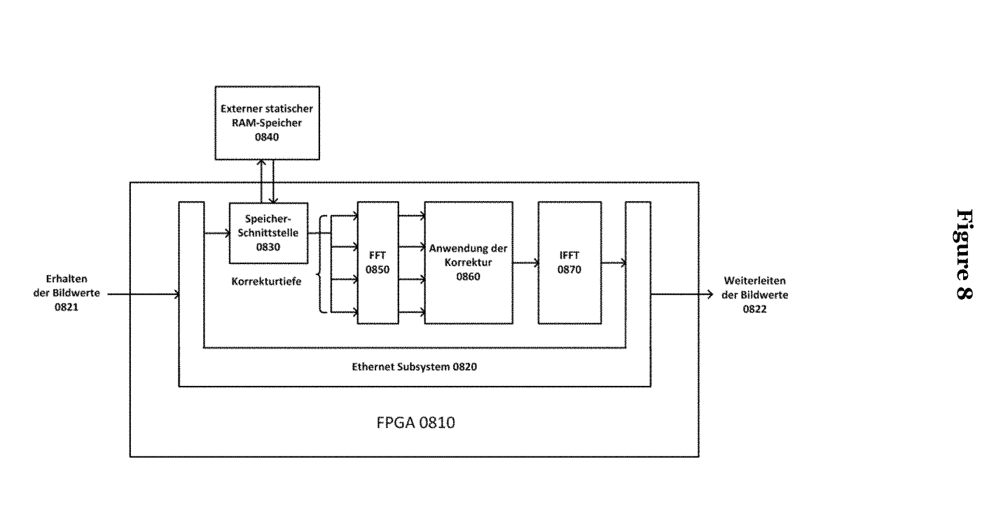

FIG. 8 shows a block diagram of an implementation of a method according to one embodiment of the invention on an FPGA 0810.

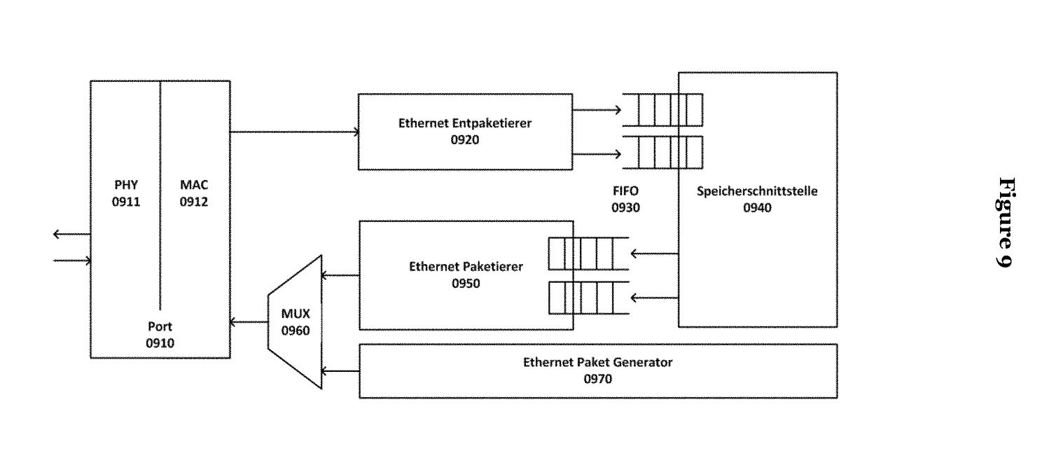

FIG. 9 shows the blocks of the Ethernet subsystem according to one embodiment of the invention.

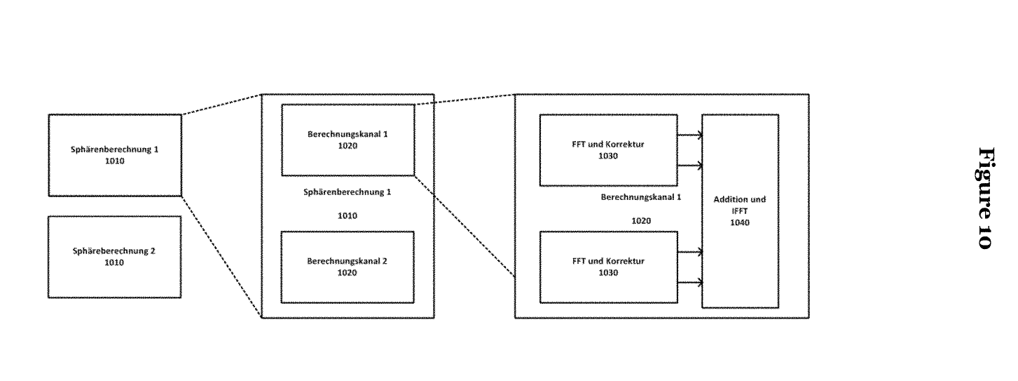

FIG. 10 shows the parallelizations in the architecture according to one embodiment of the invention.

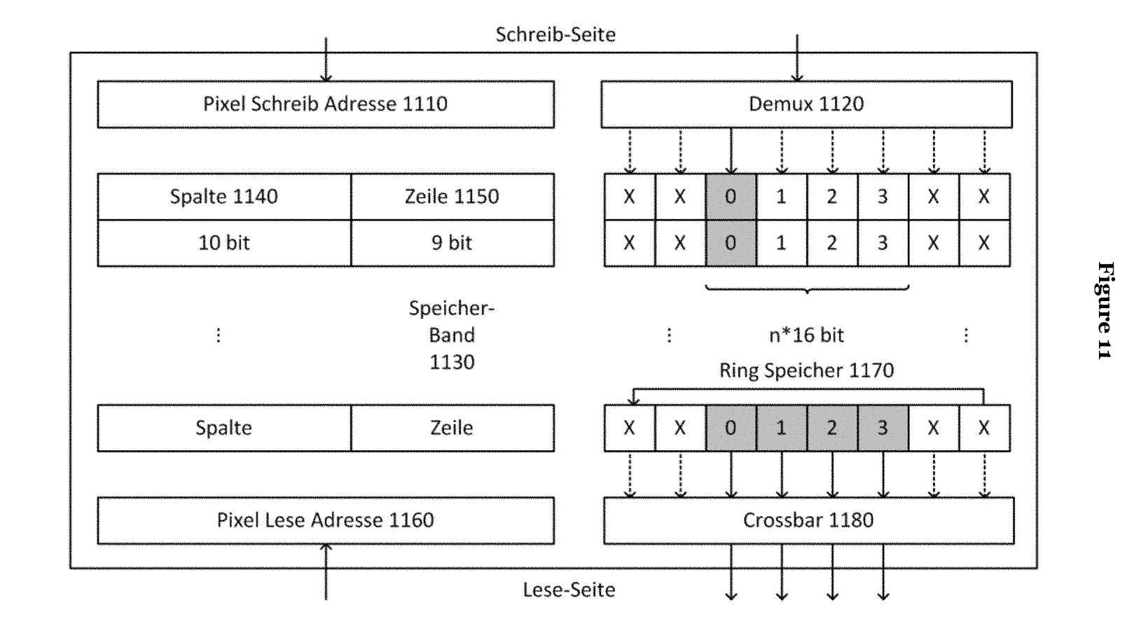

FIG. 11 shows a functional memory diagram of the external QDR II+RAM with functions of the memory interface according to one embodiment of the invention.

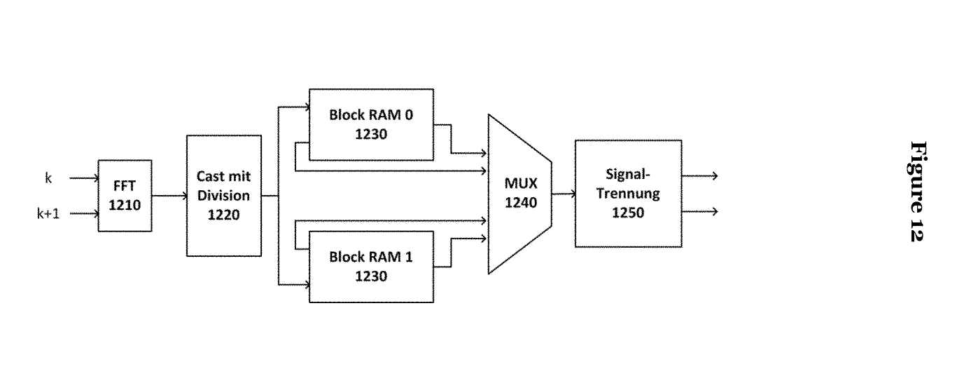

FIG. 12 visualizes the architecture, which Fourier-transforms two half columns by means of a circuit according to one embodiment of the invention.

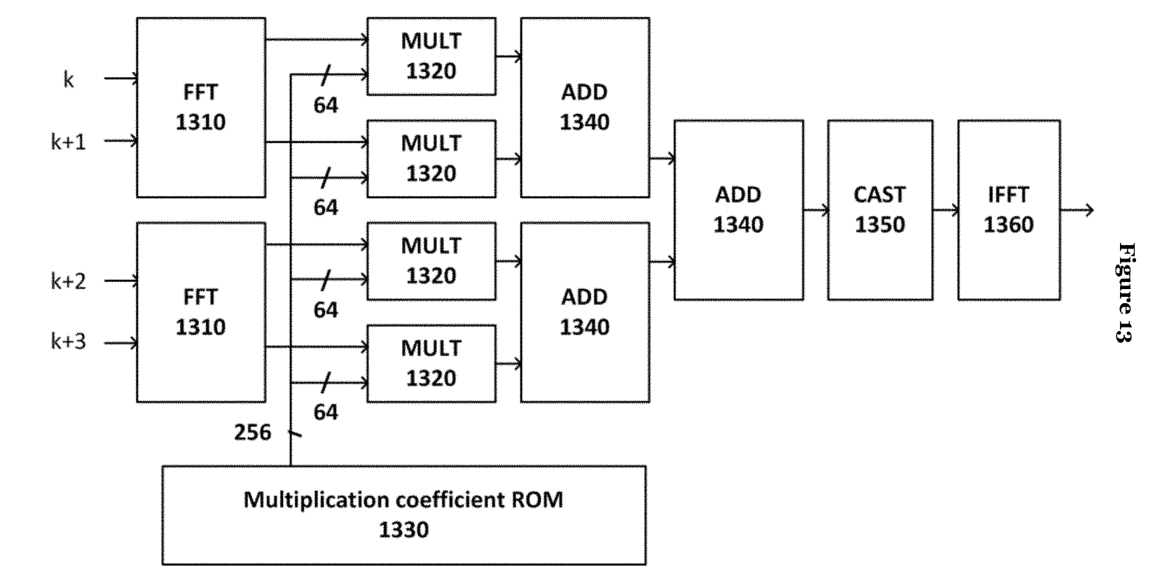

FIG. 13 shows the detailed structure of a calculation channel according to one embodiment of the invention.

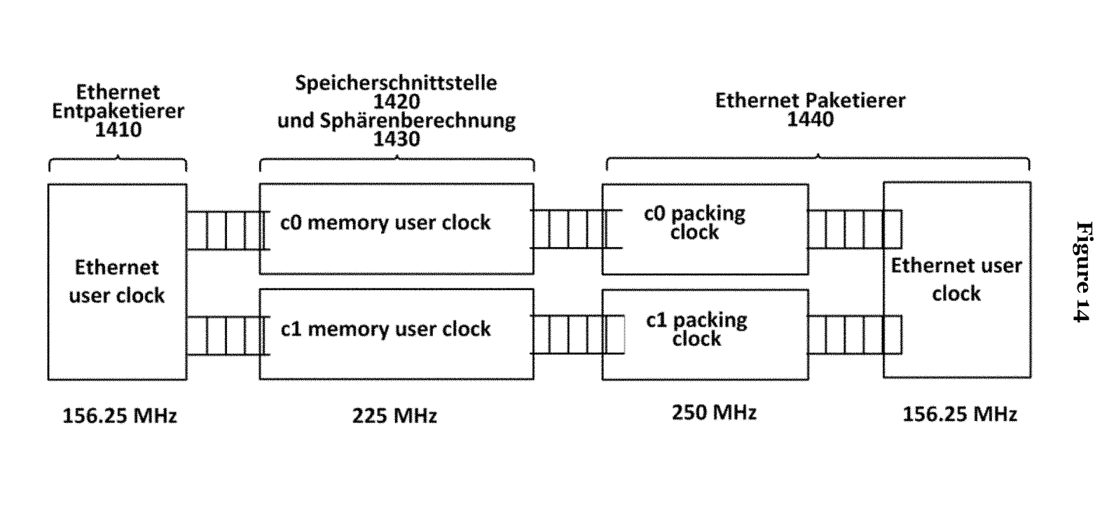

FIG. 14 shows the cycle domains of the entire circuit according to one embodiment of the invention.

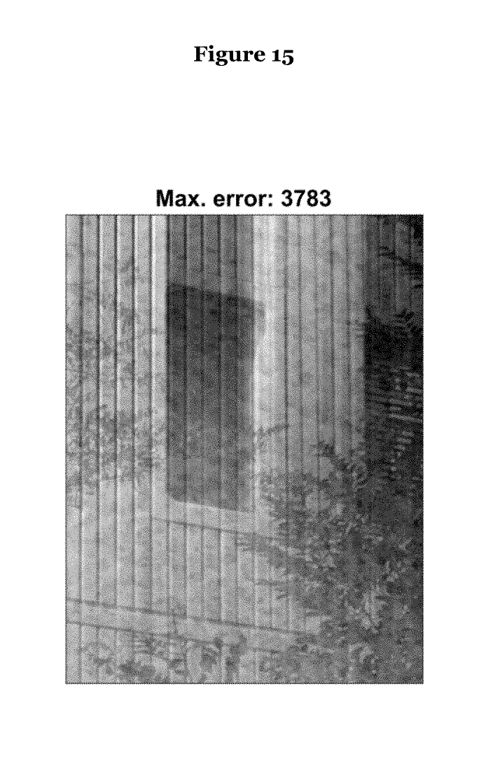

FIG. 15 is a differential image between an original image and a degraded image with smear before a correction and has a maximum error of 3783 uint16 units.

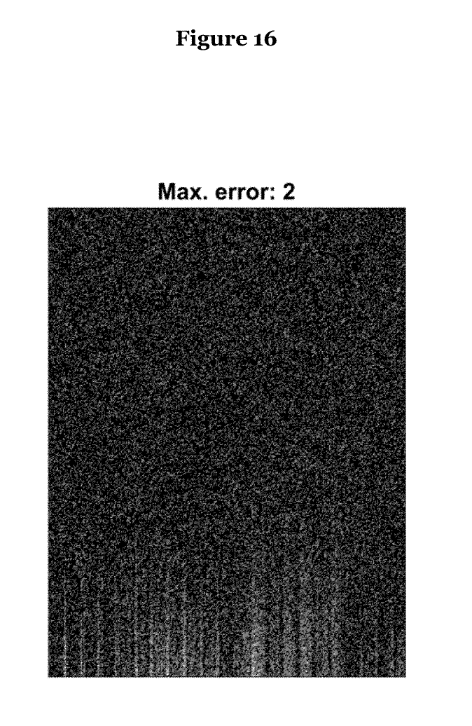

FIG. 16 shows the same differential image as FIG. 15, but after the correction by the circuit.

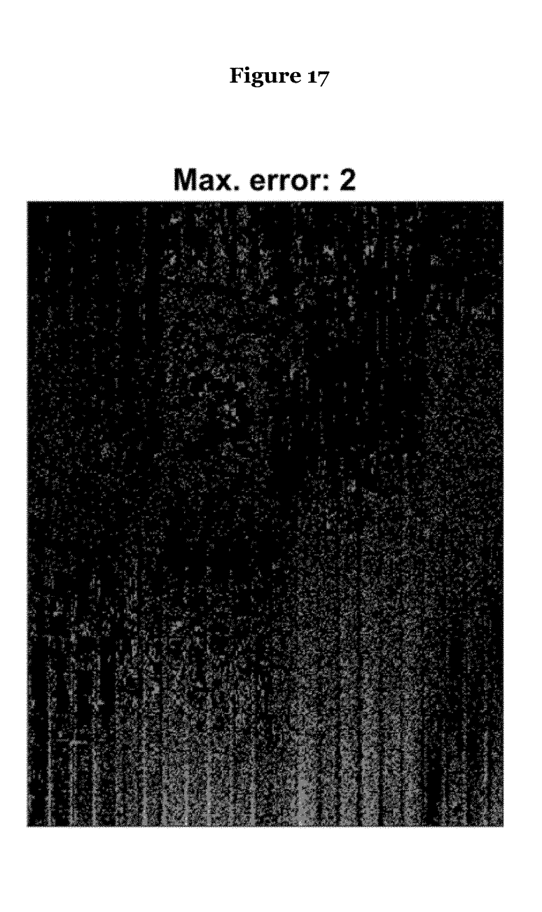

FIG. 17 shows the same correction as FIG. 16, but this image was calculated with a simulation software.

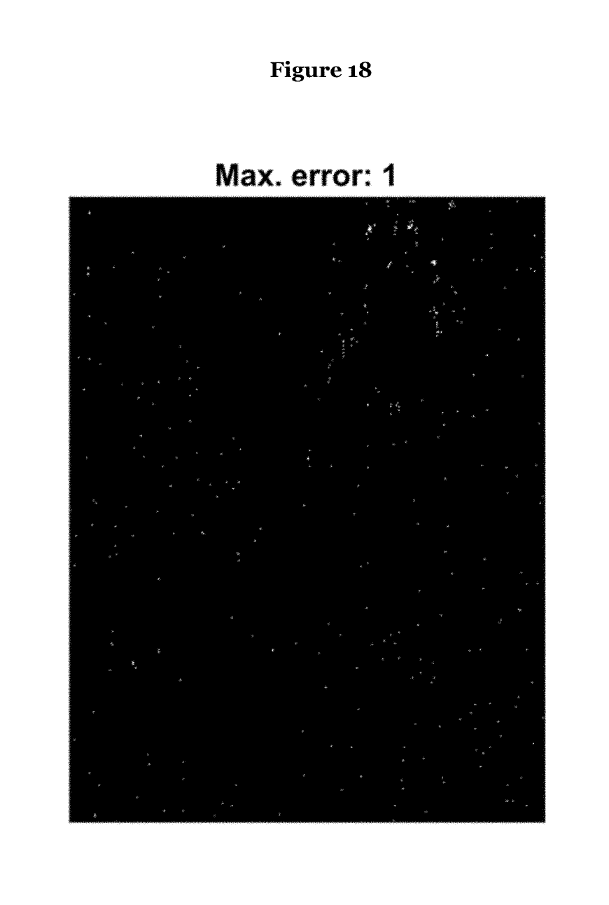

FIG. 18 was generated like the image in FIG. 17, but with a correction depth of 6 instead of 4.

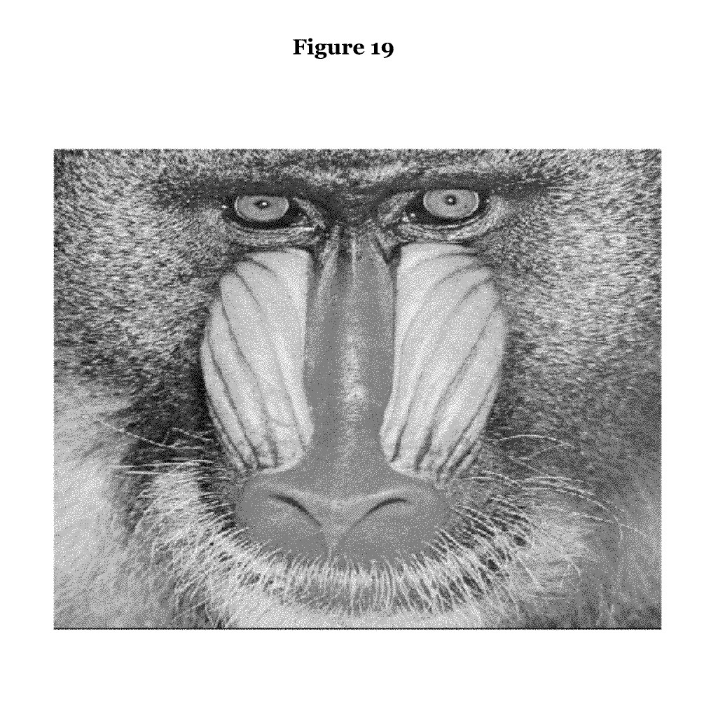

FIG. 19 shows a test image from the SIPI database.

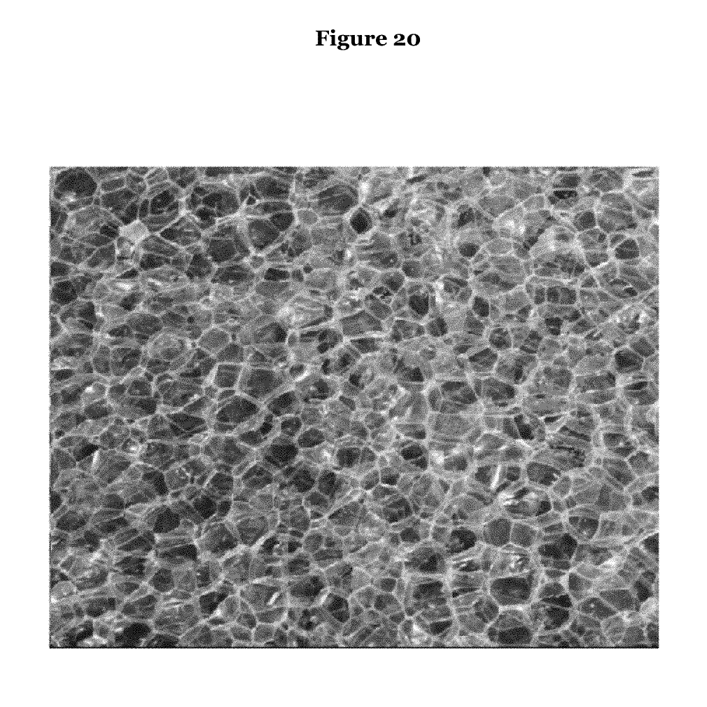

FIG. 20 shows a test image from the SIPI database.

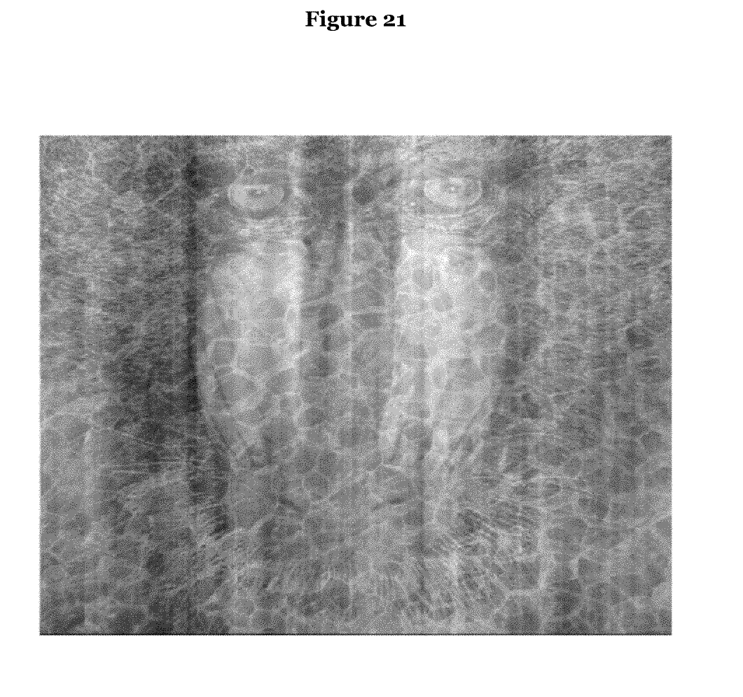

FIG. 21 shows the smear of the image in FIG. 19 after degradation in the aperiodic scenario with realistic parameters.

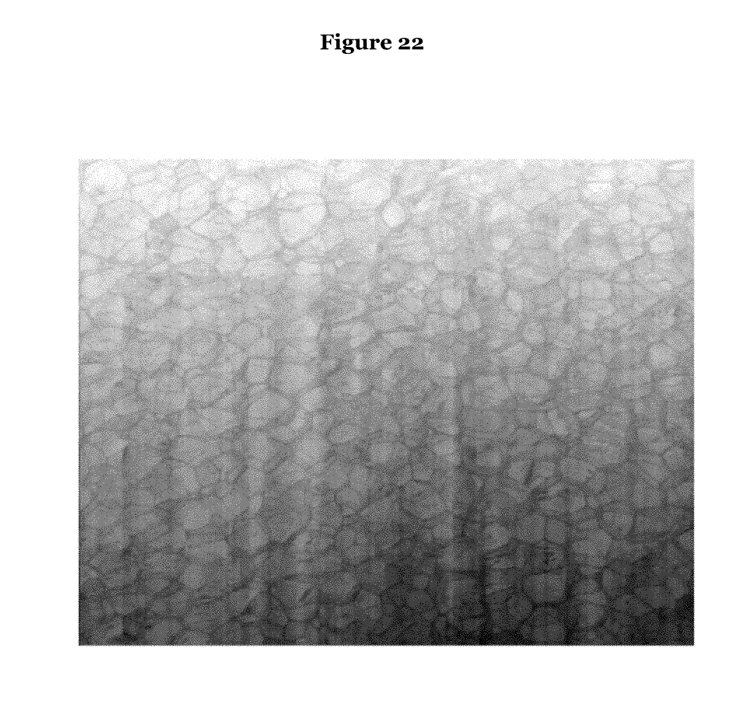

FIG. 22 shows the image from FIG. 21 after a correction with a correction depth of 1.

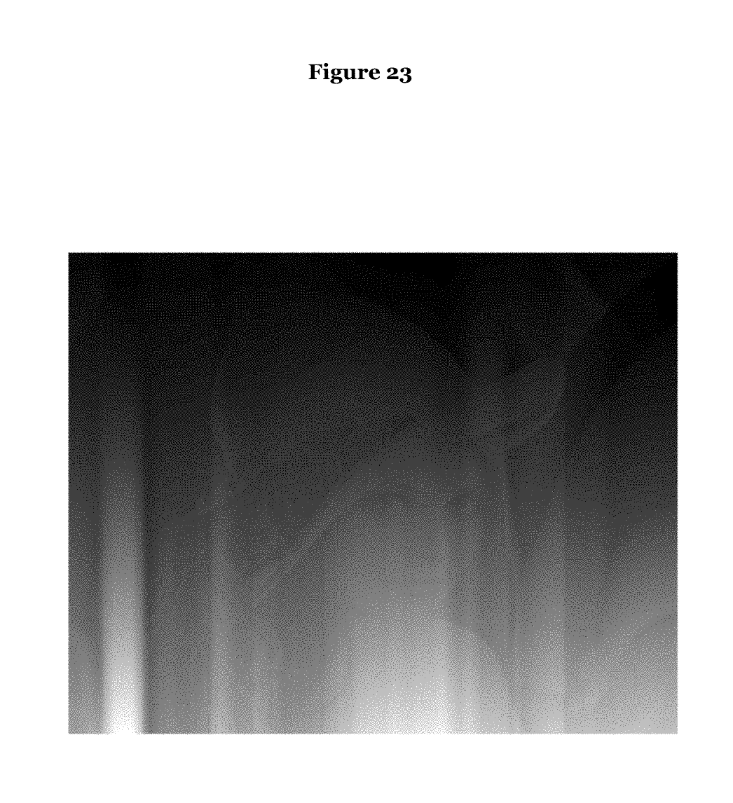

FIG. 23 shows the image from FIG. 19 after a correction with a correction depth of 2, whereby the next image in the series becomes noticeable.

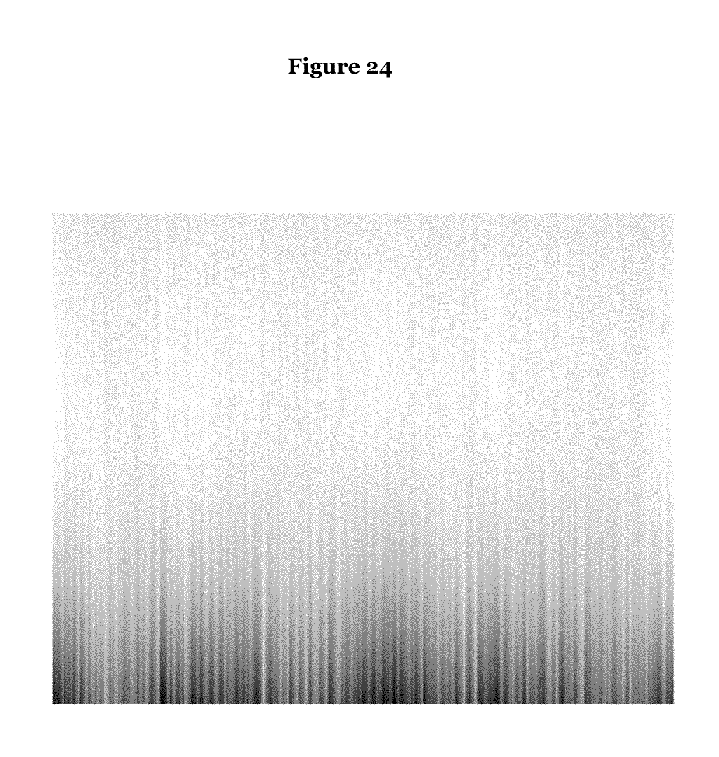

FIG. 24 shows the image from FIG. 19 after a correction with a correction depth of 4.

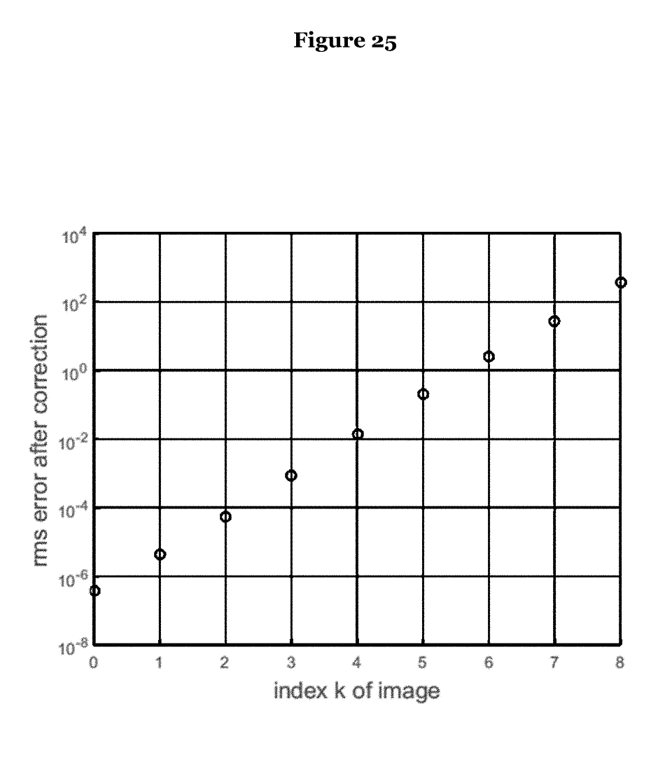

FIG. 25 shows simulation results for the approach of the periodic scenario towards the aperiodic scenario.

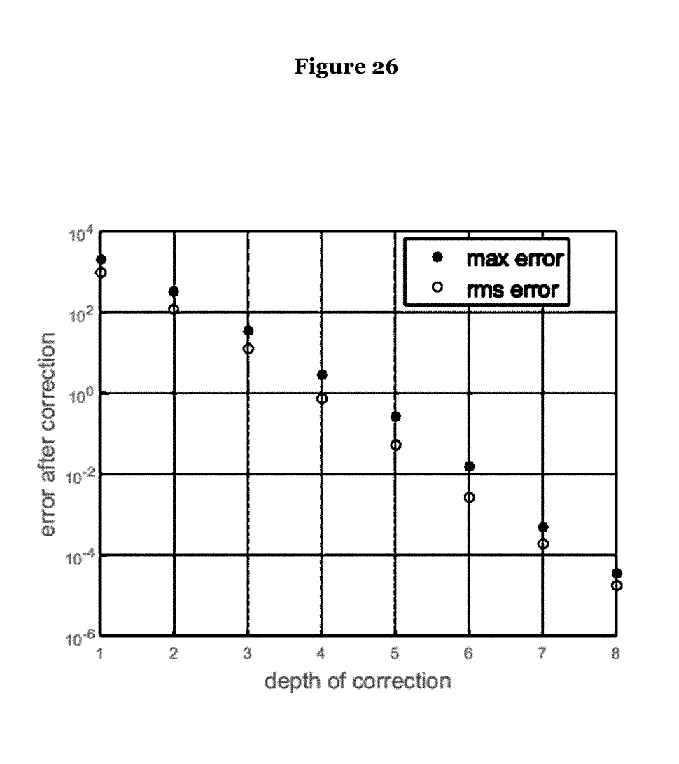

FIG. 26 now shows the periodically approximated correction of an aperiodically smeared image sequence.

FIG. 1 shows a method for the correction of readout smear according to a first embodiment of the invention. Correction values are determined based on a camera setting, which specifies for example exposure times, transfer times or times of scene change 0121. These correction values are transformed into a frequency range 0122 and are available as data 0123. They retain their validity for an adjustment of the camera. With a CCD without shutter, charges are created 0131, which are further converted into image values 0132. Such creation of image values can also comprise in particular the expansion of image values or the partitioning of image values. These image values are also available as data 0133 and are transformed 0134. An application of the correction 0135 takes place through processing of transformed image values and transformed correction values.

According to the invention, it is taken advantage of that the inverse of the circulant matrix M is in turn circulant. The matrix-vector multiplication thus corresponds with a folding:

Y=M⁻¹S=M⁻¹[1,:]*S= [symbol] ⁻¹( [symbol] )(M⁻¹[1,:])o [symbol] (S))

Here, matrix M⁻¹ corresponds with the correction values, matrix S corresponds with the uncorrected image values (with smear) and matrix Y corresponds with the corrected image values. F is the Fourier transformation.

Matrix M is inverted. Instead of multiplying the inverse with the vector S, the first row of the inverse matrix is folded with the vector S. The reduction in complexity is based on the fact that a Fourier transformation with the length of a whole-number potency of 2 is used in order to thereby calculate the folding as an element-by-element multiplication in the frequency range. A signal, the length of which is not a potency of 2, can be brought to a corresponding length through expansions with zeros (zero padding). The matrix is thereby expanded so that they remain circulant.

The vector Y was further calculated using division. Thus, the first row of M can be transformed into the frequency range and then calculated as divisor element-by-element with the transformed one from S as dividend as long as the divisor has no zero elements.

All algorithms of the prior art refer to one column of the signal. However, the signal of a CCD normally consists of several columns. Thus, the two-dimensional signal of a CCD can also be transformed two-dimensionally in order to perform the smear correction in the two-dimensional frequency space. Three-dimensional frequency spaces are also suitable for correcting series of images. Here, the first row of the inverse of M is expanded with zeros to the dimension of the signal to be corrected and transformed into multi-dimensional frequency space. The correction takes place in turn through element-by-element multiplication with the signal.

A subsequent back-transformation 0136 generates corrected image values 0137 as data. The method can be restarted with a new camera setting. Further image values with the same camera setting can be processed in a new correction. Further, several image values can be generated for a correction 0133, 0131, 0132.

In a further embodiment of the invention, a method is suggested, which calculates the readout smear for the case of charge-flush and reverse clocking operations in the frequency range.

The starting point here is the knowledge that the matrix M in these cases forms a Toeplitz matrix in the form of a lower triangle.

In order to be able to implement the correction according to the invention, the matrix M is expanded from this type of a Toeplitz matrix to a circulant matrix:

$$\begin{matrix}( \begin{matrix}Y \\ Z\end{matrix} ) = {M}_{cat}^{- 1} ( \begin{matrix}S \\ 0\end{matrix} ) : {M}_{cat}^{- 1} \\ = {[ \begin{matrix}\begin{matrix}1 & 0 & … & 0 \\ t * δ & 1 & … & 0 \\ ⋮ & ⋮ & ⋱ & ⋮ \\ t * δ & t * δ & … & 1\end{matrix} & \begin{matrix}t * δ & t * δ & … & t * δ \\ 0 & t * δ & … & t * δ \\ ⋮ & ⋮ & ⋱ & ⋮ \\ 0 & 0 & … & t * δ\end{matrix} \\ \begin{matrix}t * δ & t * δ & … & t * δ \\ 0 & t * δ & … & t * δ \\ ⋮ & ⋮ & ⋱ & ⋮ \\ 0 & 0 & 0 & 0\end{matrix} & \begin{matrix}1 & 0 & … & 0 \\ t * δ & 1 & … & 0 \\ ⋮ & ⋮ & ⋱ & ⋮ \\ t * δ & t * δ & … & 1\end{matrix}\end{matrix} ]}^{- 1}\end{matrix}$$

Here, matrix Z contains unused information, expansions, i.e. image values or correction values that are not needed but are present. The δ parameter describes the ratio of transfer time to exposure time; the α parameter describes the ratio of time needed during a scene change to the exposure time; the t parameter is an index (1 or 2), wherein t=1 for charge flush and t=2 for reverse clocking.

The inverse of the expanded matrix is in turn circulant so that its first row in turn represents a transfer function. For this, the matrix M must be expanded from at least double its original size minus 1. However, the matrix M can also be expanded to larger sizes. In particular, the matrix M was expanded to a size, which is an integral potency of two so that the transformation for the smear correction can be calculated quickly. The vector S is expanded to the same size as the row length of M in that zeros are filled up. The ones transformed from S and the inverse of M can then be multiplied in the frequency range element-by-element. A back transformation of this product then contains the corrected signal at the upper position. The lower values of the retransformed vector are discarded. The number of discarded values is the number of values with which the vectors were initially expanded. Discarded values were labeled with Z.

According to a further embodiment of the invention, the periodic scenario according to Iglesias can also be calculated in the frequency range. Based on the knowledge that the block-circulant matrix M is circulant if both delta values are the same and the inverse of this matrix is then also circulant, the correction can take place again according to the invention by means of folding and thus very efficiently. This prerequisite is given in the normal operation of the CCD sensor. The first row of the inverse can be folded with the smear-degraded signal in order to calculate the signal without smear.

An element-by-element multiplication in the frequency range makes this type of calculation faster than a matrix-vector multiplication.

According to a further embodiment of the invention, the aperiodic scenario according to Iglesias can also be calculated more efficiently. The aperiodic scenario is thereby calculated according to the invention only up to a certain correction depth n and is simplified to:

$${Y}^{k} \approx {\sum }_{j = 0}^{n} {H}^{j} {A}^{- 1} {S}^{k + j}$$

For the approximation of the solution of the aperiodic scenario according to the invention, the periodic scenario is used according to the invention:

$$S = MY : ( \begin{matrix}{S}^{k} \\ {S}^{k + 1} \\ {S}^{k + 2} \\ ⋮ \\ {S}^{k + n}\end{matrix} ) = [ \begin{matrix}A & B & 0 & … & 0 \\ 0 & A & B & … & 0 \\ 0 & 0 & A & … & 0 \\ ⋮ & ⋮ & ⋮ & ⋱ & ⋮ \\ B & 0 & 0 & … & A\end{matrix} ] ( \begin{matrix}{Y}^{k} \\ {Y}^{k + 1} \\ {Y}^{k + 2} \\ ⋮ \\ {Y}^{k + n}\end{matrix} )$$

k=index (time unit of the column)

K=periodicity in the periodic scenario

A, B=matrices according to Iglesias (blocks of M)

Here, the periodic scenario implies an error at the signal value Ŷ(k+n), which on the other side makes the matrix M circulant if delta_1=delta_2. Through the circulant matrix M, the aperiodic scenario can be represented in the frequency range as:

$$( \begin{matrix}{Y}^{k} \\ Z \\ Z \\ ⋮ \\ Z\end{matrix} ) = {ℱ}^{- 1} ( ℱ ( {M}^{- 1} [ 1 , : ] ) ∘ ℱ ( ( \begin{matrix}{S}^{k} \\ {S}^{k + 1} \\ ⋮ \\ {S}^{k + n - 1} \\ 0\end{matrix} ) ) )$$

The vector Ŝ(k+n) calculated with the error is set to zero. Thus, n columns Ŝ(i) are used to correct a column Ŷk. Other columns Ŷ(k+i) are discarded after the calculation and are marked with Z. As a result, Ŷk quickly converges to its true value with increasing n.

The number of columns n used for the correction is called the correction depth.

The expansion of a Toeplitz matrix to a circulant matrix can be used to allow the methods to be parallelized. Square blocks can be cut out of the Toeplitz matrices or the circulant matrices. These blocks are then always Toeplitz matrices. These Toeplitz matrices can be expanded to circulant matrices. The calculation can thereby be parallelized in all shown scenarios. For example, in the aperiodic scenario:

$$( \begin{matrix}{Y}^{k} \\ Z \\ ⋮ \\ Z \\ Z\end{matrix} ) = [ \begin{matrix}{T}^{k} & {T}^{k + 1} & … & {T}^{k + n} & Z \\ Z & Z & … & Z & Z \\ ⋮ & ⋮ & ⋱ & ⋮ & ⋮ \\ Z & Z & … & Z & Z \\ Z & Z & … & Z & Z\end{matrix} ] ( \begin{matrix}{S}^{k} \\ {S}^{k + 1} \\ ⋮ \\ {S}^{k + n - 1} \\ 0\end{matrix} )$$

The relevant blocks T̂i for the calculation of Ŷk are created here. The formula can therefore be written as:

$$( \begin{matrix}{Y}^{k} \\ Z\end{matrix} ) \approx {ℱ}^{- 1} ( {\sum }_{j = 0}^{n - 1} ℱ ( {T}_{ext}^{k + j} [ 1 , : ] ) ∘ ℱ ( {S}^{k + j} ) )$$

The individual terms in the sum can thus be calculated in parallel. The same is possible for the standard scenario, the periodic scenario as well as charge flush and reverse clocking. The ability to parallelize can take place in the software and in the hardware and enables a lower power consumption of the calculation or a higher hardware usage.

FIG. 2 shows the schematic structure of a full-frame CCD. The photosensitive matrix 0210 serves to create a charge in the elements 0230 and is connected to at least one device for image generation 0220 through the directed charge transport. All elements of the photosensitive matrix are also attached to at least one such charge transport. The charges are shifted in the transport direction before and after exposure, whereby the charge is increased additively in other elements of the matrix when a shutter is not used. Since each shifted charge is illuminated in other elements, a readout smear is created by the full-frame architecture.

FIG. 3 shows the schematic structure of a frame-transfer CCD. The photosensitive matrix 0310 serves to create a charge and is connected to a device for image generation 0350 via a framestore matrix 0330. Elements 0320 of the photosensitive matrix are interconnected for charge transport. The charge transport takes place via the elements 0340 of the framestore matrix in the direction of image generation. During the transports before and after the exposure, charges are further illuminated in the elements of the photosensitive matrix. Without a shutter, this exposure results in readout smear during transport.

FIG. 4 shows the structure and the process for image generation in the Fast Solar Polarimeter camera. The sensor is subdivided into two spheres 0410. Both spheres are made up of a photosensitive matrix 0411 and a framestore matrix 0412. Each half column 0420 of a photosensitive matrix is shifted in the shifting direction 0430 into the framestore matrix of the same sphere after the exposure. The process of the image degradation through smear takes place in this process. The readout of the charges occurs in the readout direction 0440. Since the readout direction is not equal to the shifting direction, it becomes necessary to rotate the image during the smear correction. The process of image formation is divided into four phases: shifting in 0450, exposure 0460, scene change 0470 and shifting out 0480. The actual image values are obtained through the exposure at the correct position of the pixel. Every other phase leads to an additive charge in each pixel, which passes through this charge and thus causes smear. These additive charges are proportional to the amount of time the shifted charge spends in the pixel. These phase-related times are specified as a fraction relative to the exposure time 0490. Moreover, the formation of the image with smear depends on the scene. The image with smear is thus always specified depending on the relative proportion of the exposure time and the radiation incidence caused by the scene.

FIG. 5 shows measurement results for comparing a floating-point data format with several fixed-point data formats with different bit widths. The accuracy of several hardware implementations of Fourier transformations were examined for different implementation types, data formats and bit widths. Significant differences were not found for different implementation types; however, Fourier transformations of the camera data are calculated more exactly in fixed-point representation than in floating-point representation. Further, the accuracy of the fixed-point representation scales with the bit width of the fixed-point data format.

FIG. 6 shows measurement results for the aperiodic correction of images smeared periodically with a periodicity of four. The depth of the correction is variable here. The mean error in the differential image was calculated from the corrected image to the original image. It was identified that a correction depth between four and six images is sufficient in order to obtain a sufficient accuracy of the correction. Minimized computer effort is simultaneously ensured by restricting the correction depth. Smaller correction depths have more errors; higher correction depths only reach insignificantly higher accuracies.

FIG. 7 shows the average signal value of difference images between aperiodically corrected and original, non-degraded images. The aperiodic correction was performed in the transformation with variable width of phase values. It was determined that the transformation with bit width 13 should have a phase value width of 24 bits.

Besides different methods, the invention comprises hardware implementations for smear correction. The hardware implementation was developed for a scientific camera, which is based on a framestore CCD. At 400 images per second, a mechanical shutter is not feasible. For real time smear correction, the aperiodic scenario was implemented in hardware. The camera sensor consists of two spheres with their own framestore area. The images of each sphere are corrected independently. The images are then rotated on a random access memory and saved with a correction depth of 4 or 6 images. The saving takes place with memory mapping, in that the same pixels from images with a different time index are located next to each other in the memory tape. In this manner, read access, which has higher throughput, is optimized instead of write access. It was determined that memory is the critical resource; thus, the images of the correction depth were saved in the intensity area, which requires less memory and more Fourier transformations. However, the images can also be transformed first and then saved, which requires more memory and less computing power. The data formats of a transformation-based solution were compared. In particular, fixed-point-and floating-point-based methods were evaluated in both hardware and software. The fixed-point-based methods are more convenient overall but are less flexible. Mixed methods that use fixed-point-based transformations were thus implemented; however, the actual correction between the transformations is calculated with floating point. These mixed methods reduce the hardware requirements while maximizing accuracy. Here, the integer values of the original image were always cast so that the resulting fixed- and floating-point data formats prevent a number range overrun and the accuracy of the calculation is simultaneously maximized. Hardware-based Fourier transformations generally have a complex input. The transformations were thus implemented so that two signals are simultaneously calculated in a hardware module for Fourier transformations, wherein a signal is placed on the real input of the module and the other signal is placed simultaneously on the imaginary input of the module. The resulting output signal was then broken down into two transformations of the respective input signals. The correction depth was subsequently measured. In a positive 16-bit data format, a correction depth of 4 can be considered sufficient for the camera because the error from smearing is subsequently lower than the error from the readout noise.

FIG. 8 shows the block diagram of an implementation on an FPGA 0810. The sub-system for the Ethernet communication 0820 partially implements the receiving of the image values 0821 but also a forwarding of the corrected image values 0822. The image values with smear are written to an external static RAM memory 0840 via a memory interface 0830. During the writing, the image is turned. During the reading, image values are parallelized to the width of the correction depth. These parallel values are transformed into the frequency range by means of fast Fourier transformations 0850. The use of the correction 0860 then takes place. Finally, the corrected image values are transformed back into the intensity range with an inverse Fourier transformation 0870. These retransformed image values are transferred back to the Ethernet subsystem in order to forward them on.

FIG. 9 shows the blocks of the Ethernet subsystem. A port 0910 is made up of the physical layer PHY 0911 and the Medium Access Control MAC 0912 and implements the communication via a 10-gigabit Ethernet cable. An Ethernet depacketizer 0920 removes the packet overflows from the net data and writes each to one FIFO cache 0930 per sphere. The FIFO caches forward the net data to the memory interface 0940. FIFO caches also connect the Ethernet packetizer 0950 to the memory interface, which packetizes corrected image values to be sent in Ethernet packets. Here, the FIFO cache assumes the function of managing backups. Cycle domains are decoupled in both directions. A multiplexer 0960 can add an Ethernet packet generator 0970 to the data flow in order to create a test data flow with a higher throughput.

FIG. 10 shows the parallelizations in the architecture. Each correction of the images per sphere takes place in one sphere calculation 1010. Thus, there are two modules for two spheres. Each sphere calculation is subdivided in turn into two calculation channels 1020. These channels are structured the same and work in the temporal multiplex process. Each calculation channel in turn contains two transformation and correction modules 1030. Each of these modules processes synchronously two half columns, whereby a correction depth of 4 is achieved. All half columns are then transferred synchronously to the module for addition and back transformation 1040, which adds the signals and transforms them into the intensity range.

FIG. 11 shows a functional memory diagram of the external QDR II+RAM with functions of the memory interface. The memory was subdivided into a write and read side. The write side is connected to the Ethernet subsystem via the memory interface. One pixel is written per cycle. The write address 1110 is assigned during write access and a demultiplexer 1120 places the image value of one pixel with the correct offset into a memory word. The word is a unit of memory tape 1130 and is addressed with column index 1140 and row index 1150. The same pixel of following images is written to the same address in the memory tape but with incremental offset. If a word is addressed while reading 1160, a memory word always functions as ring buffer 1170 since several identical pixels are read out in parallel with a different time index. This requires for one a crossbar 1180 on the read side. On the other hand, the half columns to be processed are read out, which is determined by the addressing.

FIG. 12 visualizes the architecture, which Fourier-transforms two half columns by means of a circuit. The complex input of the actual forwards-Fourier transformation 1210 is used for a second half column. Both half columns are from the same position with neighboring time index k. The transformed, doubled half columns are written to one of the two block RAMs 1230 since the readout must happen forwards and backwards simultaneously via the two outputs of the RAM. The other block RAM writes the next doubled signal since the throughput is briefly doubled by write and read access to the RAM. Accordingly, a multiplexer 1240 is needed behind the RAMs. It multiplexes to a mathematical logic unit 1250, which serves to separate both transformed, individual half columns. Overall, this circuit saves resources compared to two transformations.

FIG. 13 shows the detailed structure of a calculation channel. On the input side, two blocks 1310 are instantiated, each of which transform two identical half columns with a different time index. These transformed columns are multiplied with the pre-calculated, transformed correction values each in a complex multiplier 1320. The complex correction values are saved for this in a ROM 1330. The products are subsequently added in steps in complex adders 1340, transferred per typecast 1350 into fixed-point data formats and transformed back into the intensity range by a circuit for Fourier transformations 1360.

FIG. 14 shows the cycle domains of the entire circuit. The cycle of the Ethernet depacketizer 1410 is derived from the Ethernet subsystem. The sphere calculation unit 1430 and the memory interface 1420 are supplied with separate cycles. The Ethernet packetizer 1440 partially requires a higher cycle since headers must be added. The transfer of the packets into the Ethernet data flow is again synchronous with the cycle of the Ethernet subsystem.

FIG. 15 is a differential image between an original image and a degraded image with smear before a correction and has a maximum error of 3783 uint16 units.

FIG. 16 shows the same differential image as FIG. 15 but after the correction by the circuit. The error was reduced to a maximum value of 2 with a correction depth of four.

FIG. 17 shows the same correction as FIG. 16, but this image was calculated with a simulation software. A good agreement is detected between software- and hardware-based correction.

FIG. 18 was generated like the image in FIG. 17, but with a correction depth of 6 instead of ₄. Only individual rounding errors can still be detected. The maximum fault is 1 in uint16.

FIG. 19 shows a test image from the SIPI database. It served as the first of 10 test images for generating aperiodic smear. Source link on date of filing: http://sipi.usc.edu/database/download.php?vol=misc&img=4.2.03

FIG. 20 shows a test image from the SIPI database. It served as the second of 10 test images for generating aperiodic smear. Source link on date of filing: http://sipi.usc.edu/database/download.php?vol=textures&img=1.1.13)

FIG. 21 shows the smear of the image in FIG. 19 after degradation in the aperiodic scenario with realistic parameters.

FIG. 22 shows the image from FIG. 21 after a correction with a correction depth of 1.

FIG. 23 shows the image from FIG. 19 after a correction with a correction depth of 2, whereby the next image in the series becomes noticeable.

FIG. 24 shows the image from FIG. 19 after a correction with a correction depth of 4.

FIG. 25 shows simulation results for the approach of the periodic scenario to the aperiodic scenario. The index k is plotted against the error of a periodic correction within an aperiodic image sequence. It can be seen that the first image with k=0 is corrected very well and has a small error. However, this error increases with increasing index k. This finding was used for the approach of the aperiodic scenario with the periodic scenario.

FIG. 26 now shows the periodically approximated correction of an aperiodically smeared image sequence. The first image in a series was always corrected, but with variable correction depth. It can be seen that the maximum absolute error and the average error decrease with increasing correction depth.

Lastly, options for correcting readout smear on processors and graphic cards were examined. It was shown that the processing of columns or the options of the described parallelization benefits a calculation for single-instruction-multiple-data architectures. Thus, graphic cards and processors with vector command sets are certainly suitable for executing the implementations mentioned.

The hardware and software implementations mentioned can be used in several commercial applications. Scientific sensors require high fill factors of the pixels, whereby the need to reduce other structures on the sensor results. Since such structures can also serve to reduce readout smear, for example in Interline transfer CCDs, a software correction of readout smear is important. If this correction then takes place in real time, the implementations mentioned are more efficient and resource-saving than the prior art, which in turn justifies their use and thus their commercial application. Further, the implementations mentioned can be used to lower the latency of an image correction. This is important in particular in consumer photography, where a user wants to view a picture in less than a second. A fast correction can be used here since it achieves a latency advantage of a factor of approximately 10 in the case of a megapixel resolution like in current systems. Conversely, due to such an advantage, CCD sensors can also be installed in end devices in which they were not previously used, for example in smartphones. Here, enough computing power is present for a fast correction so that readout smear is consciously permitted and can be corrected post-facto within a short period of time.

1. A method for correcting smear artifacts, comprising:
readout of created charges from a matrix of photosensitive elements (CCD);
conversion of the readout charges into image values;
determination of correction values for correcting smear artifacts;
transformation of image and correction values with a suitable transformation; and
correction of the transformed image values based on the transformed correction values.

2. The method according to claim 1, wherein the photosensitive elements (CCD) are implemented in a framestore or a full-frame architecture.

3. The method according to claim 1, characterized in that the transformed correction values are calculated element-by-element with the transformed image values.

4. The method according to claim 3, characterized in that the transformed correction values are multiplied with the transformed image values.

5. The method according to claim 3, characterized in that the transformed image values are divided by the transformed correction values.

6. The method according to claim 1, characterized in that at least one correction value is used to correct several image values in one image.

7. The method according to claim 1, characterized in that the correction values form a Toeplitz matrix.

8. The method according to claim 7, characterized in that the correction values form a circulant or respectively cyclical matrix.

9. The method according to claim 1, characterized in that the correction values form a Hankel matrix.

10. The method according to claim 1, characterized in that a folding multiplication theorem applies for the transformation.

11. The method according to claim 10, characterized in that the transformation is a Fourier transformation, in particular a fast Fourier transformation.

12. The method according to claim 10, characterized in that the transformation is a z transformation.

13. The method according to claim 10, characterized in that the transformation is a sine cosine transformation.

14. The method according to claim 1, wherein the correction of variable scenes is approximated by the assumption of periodically occurring scenes.

15. The method according to claim 1, wherein the corrections are executed incompletely up to a certain correction depth.

16. The method according to claim 1, wherein the correction of the smear artifacts takes place in real time.

17. The method according to claim 1, wherein rotations of the image are performed in a memory.

18. The method according to claim 1, wherein several image values are transformed in one transformation.

19. The method according to claim 1, wherein the integral image values are converted into fixed-point or floating-point or mixed data formats.

20. The method according to claim 1, wherein additionally a correction takes place for a dark-field image and a flat-field image.

21. The method according to claim 1, wherein the sensor is divided into several individual spheres.

22. The method according to claim 14, wherein the same pixels of several images are located near each other in a memory, so that they can be accessed in a parallel manner.

23. The method according to claim 1, wherein image values are stored in the memory.

24. The method according to claim 23, wherein the stored image values were previously transformed to save computing capacity.

25. The method according to claim 1, wherein several correction values are saved.

26. The method according to claim 1, wherein platform-specific commands for vector calculations or single-instruction-multiple-data are used for the correction.

27. The method according to claim 7, which uses the parallelizability, which occurs in the case of a division of a Toeplitz matrix into several Toeplitz matrices.

28. A computer program product, comprising machine-readable program instructions, which perform a method according to claim 1 on a computer.

29. The computer program product according to claim 28, in the form of loadable app for mobile devices.

30. A device for correcting smear artifacts, comprising:
an interface for obtaining image values;
an interface for determining correction values for correcting smear artifacts;
a circuit for transforming the image and correction values with a suitable transformations; and
a circuit for applying the transformed correction values to the transformed image values,
wherein the device is set up to perform a method according to patcnt claim 1.

31. The device according to claim 30, wherein the correction values are saved in a memory.
